(19) United States
(12) Patent Application Publication
(10) Pub. No.: US 2012/0247007 A1
(43) Pub. Date: Oct. 4, 2012

(54) METHOD IN COMMERCIAL MUSHROOM HARVESTING

(76) Inventors: Jacobus Henricus Johannes Verdellen, Melderslo (NL); Nader Gheshlaghi, Richmond Hill (CA)

(21) Appl. No.: 13/389,100

(22) PCT Filed: Aug. 9, 2010
(86) PCT No.: PCT/NL1200/050501

§ 371 Date: Jun. 20, 2012

(30) Foreign Application Priority Data
Aug. 7, 2009 (NL) 1037183

(51) Int. Cl. A01G 1/04; A01D 46/00

(52) U.S. Cl. 47/1.1

(57) ABSTRACT

A method for mushroom cultivation is developed which requires no manual picking and a limited packaging step. The invention also induces lesser chances of contamination and provides longer shelf life to the mushrooms. The device used for production of mushrooms comprises two parts, one basal plate perforated with holes for the mushroom pins to emerge into the container. The apertures/holes on the base of the container may be covered with casing material. The other portion is the top part functioning as a cover which could be used to secure the container in order to prevent contamination from out side, maintain the moisture level and also maintains the micro environment for growing mushrooms. The top cover is preferably also perforated for the escape of excessive moisture. When mushrooms are ready to pick, the whole container is removed and preserved at a lower temperature, such as 4° C. in a cooler or refrigerator. This method will significantly reduce the cost of mushroom production by virtually eliminating the process of harvesting and packaging. This technique of mushroom cultivation also enhances the shelf life by minimizing the level of contamination due to direct human touch and minimum exposure to the outer environment.

### TECHNICAL FIELD OF THE INVENTION

The present invention relates to mushroom cultivation and provides a tool and method that eliminate or minimize the harvesting process and also packaging of mushrooms.

### BACKGROUND OF THE INVENTION

Wherever food is harvested, manufactured or distributed there is a need for containers to enable the food to travel securely and in good condition to a shop, warehouse or distribution depot. For many foods, especially those in their own individual containers, such as canned vegetables, the common container is the cardboard box, Cardboard boxes are manufactured from a relatively low grade card and they are available in many sizes.

In the modern developed world, a very wide range of food containers is now available made from many different materials, such as from plastic, metal and cardboard.

Many products use low density polyethylene formed into plastic bags or plastic boxes. There are a large number of manufactures and ranges of plastic boxes.

Longer term storage or storage of items needing a higher degree of protection from the elements may use sheet metal. A common form of such storage is the biscuit tin.

Perhaps the most ubiquitous domestic item of food storage is the fridge or fridge-freezer in which a wide variety of foodstuffs are contained and preserved through the use of low temperatures.

Vegetable-type foods packed in a container, and essentially surrounded in the closed container by either vacuum or a gas atmosphere preventing deterioration of the foods, such as carbon dioxide, nitrogen or mixtures thereof, are known from European Patent Application EP-A-0,153,215.

It appears that when such a pack is used for accommodating mushrooms, their shelf life is limited, and there is rapid discolouration, which makes the product unattractive in appearance.

In EP 0564026 it has been found that the shelf life can increase considerably and the colour also remains excellent if the mushrooms are present in at least a blanched form, and if the quantity of moisture present is limited to at most the quantity which the mushrooms comprise after blanching, after the adhering moisture has been essentially removed from them.

The container used can be in many different forms. If the medium surrounding the mushrooms is a vacuum, the container will preferably be a container made of flexible plastic such as polyethylene, polypropylene or polyester.

If the medium surrounding the mushrooms is a gas atmosphere, the container can comprise at least a slightly rigid self-supporting part made of plastic, which can be closed by a plastic part which is rigid or flexible. The plastic of the container can in general be selected from transparent, uncolored plastic, transparent, coloured plastic, or coloured or uncolored plastic which is opaque to light, and combinations of such plastics. At least a part of the plastic of the container is preferably a thermoplastic material, so that the container can be sealed by the known heat-sealing techniques.

Mushroom growth has been studied during centuries.

Many species of mushrooms seemingly appear overnight, growing or expanding rapidly. In actuality all species of mushrooms take several days to form primordial mushroom fruit bodies, though they do expand rapidly by the absorption of fluids.

The cultivated mushroom as well as the common field mushroom initially form a minute fruiting body, referred to as the pin stage because of their small size (see FIG. 19). Slightly expanded they are called buttons, once again because of the relative size and shape. Once such stages are formed, the mushroom can rapidly pull in water from its mycelium and expand, mainly by inflating preformed cells that took several days to form in the primordia.

Most mushrooms that are sold in supermarkets have been commercially grown on mushroom farms. The most popular of these, Agaricus bisporus, is generally considered safe for most people to eat because it is grown in controlled, sterilized environments, though some individuals do not tolerate it well. Several varieties of A. bisporus are grown commercially, including whites, criminy, and portobello. Other cultivated species now available at many grocers include shiitake, maitake or hen-of-the-woods, oyster, and enoki.

White mushrooms, like all mushrooms, grow from microscopic spores, not seeds. Plant-like organisms growing from spores are called fungi. A mature mushroom will drop as many as 16 billion spores. Spores must be collected in the nearly sterile environment of a laboratory and then used to inoculate grains or seeds to produce a product called spawn (the mushroom farmer's equivalent of seed).

Because mushrooms have no chlorophyll, they must get all their nutrients from organic matter in their growing medium. The medium-called compost is scientifically formulated of various materials such as straw, corn cobs, cotton seed and cocoa seed hulls, gypsum and nitrogen supplements. Preparing the compost takes one to two weeks. Then it is pasteurized and placed in large trays or beds. Next the spawn is worked into the compost and the growing takes place in specially constructed houses, where the farmers can regulate crucial aspects as heat and humidity.

In two to three weeks, the compost becomes filled with the root structure of the mushroom, a network of lacy white filaments called mycelium. At that point, a layer of pasteurized peat moss is spread over the compost. The temperature of the compost and the humidity of the room must be carefully controlled in order for the mycelium to develop fully. Eventually, tiny white protrusions form on the mycelium and push up through the surface of the peat moss. Farmers call this pinning. The pins continue to grow, becoming the mushroom caps, which are actually the fruit of the plant, just as a tomato is the fruit of a tomato plant. It takes 10 to 25 days to produce mature mushrooms after the peat moss is applied. Size is no indication of maturity in mushrooms. Perfectly ripe ones vary from small buttons to large caps.

Each crop is harvested over a period of several weeks and then the house is emptied and steam-sterilized before the process begins again. The remaining compost is recycled for potting soil. Harvested mushrooms are set in carts, refrigerated and then packaged and shipped quickly to supermarkets, food processors and restaurants. The entire process from the time the farmer starts preparing the compost until the mushrooms are harvested and shipped to market takes about two to three months.

Edible mushrooms are used extensively in cooking, in many cuisines (notably Chinese, European, and Japanese). Hundreds of million kilograms are produced yearly. Though mushrooms are commonly thought to have little nutritional value, many species are high in fibre and provide vitamins such as thiamine, riboflavin, niacin, biotin, cobalamins, ascorbic acid. Though not normally a significant source of vitamin D, some mushrooms can become significant sources after exposure to ultraviolet light, though this also darkens their skin. Mushrooms are also a source of some minerals, including selenium, potassium and phosphorus. Various species as well as their production conditions are discussed below.

Criminy mushrooms are grown and harvested in the same manner as the white mushroom. The reason they have a darker colour and slightly denser texture is that they come from a different strain of spores.

Porta bella mushrooms are also grown like the white mushrooms. Actually, the Portabella is a mature Criminy. It's usually three to seven days older than the Criminy when harvested. As a result of their longer growing period, Portabellas develop much larger caps-ranging up to six inches in diameter.

Oyster mushrooms, like other mushrooms, are grown in mushroom houses but they require a bit more humidity and fresh air than the white variety. They grow well on a range of agricultural and wood waste products including hardwood chips, chopped cereal straws or corn cobs. After the growing medium is pasteurized and cooled it is inoculated, that is, mixed with spawn and packed into long, tubular shaped plastic bags. The bags are hung up or set on racks in the growing rooms. After about 14 days, the mushrooms have started growing and can be harvested subsequently. If straw is used as a growing medium, the substrate can be used as fertilizer after mushroom production is completed.

Shiitake mushrooms were originally cultivated on natural oak logs, a process which took two to four years before the mycelium colonized the wood sufficiently to produce fruiting. Shiitakes were harvested on a seasonal basis (spring and fall) for about six years. Now, however, oak sawdust is packed into poly bags, sterilized, inoculated with spawn and placed in environmentally controlled rooms. These man-made “logs” produce Shiitakes in seven weeks. The total process, from spawning to the end of harvesting takes about four months as compared to the six year cycle on natural logs.

For Enoki mushrooms, beach mushrooms and maitake mushrooms even more complex procedures are used, requiring specific control of e.g. temperature, carbon dioxide content, and humidity, as well as specific specially prepared substrate material. These mushrooms typically produces only one time, then the substrate is recycled into agri-business products. The whole process, sometimes from lab to table, takes relatively Ion, e.g. from 10 to 14 weeks.

The demand for the partially prepared and pre-packaged foods for quick preparation is increasing day by day. Among some of the fresh products which are higher in demand than ever before are the above mushrooms, as well as other vegetables, fruits and fresh herbs. The main cost involved int the production of mushrooms includes compost production, harvesting and packaging. The harvesting of mushroom is still done manually. Mushroom farmers in addition to basic procedures use their own techniques to make the process convenient, but still it is very labourious, time consuming and expensive in terms of production cost. Thus, the involvement of manual labour increases the production cost and also increases the chances of potential contamination. This creates additional maintenance problems.

Although there are some mechanical devices and methods for mushroom harvesting, these generally involve expensive technology i.e. video camera, mechanical platforms and other devices. Further, albeit chances of contamination by physically not touching the mushrooms are minimized, which in turn also enhances the shelf life, mechanically picking of mushrooms results in a much lesser quality of the product. As such, the mushrooms can only be used for directly processing the mushrooms into food products, like conservatives.

Considerable effort has been made to reduce the costs involved in production it self, but less attention has been paid towards reducing costs in harvesting and packaging.

Thus, disadvantages of the prior art method are amongst others a limited shelf life of mushrooms, due to e.g. methods of harvesting, contamination by human beings, and contamination from the growth and storing environment, labourious and therefore expensive methods of harvesting, limited area of markets, i.e. mushrooms have to be sold relatively close to a production facility, or otherwise transport costs increase dramatically, and mushrooms remain fresh only during a limited amount of time and therefore need to be transported and sold quickly.

Thus there still is a need for improved methods for harvesting mushrooms, which methods overcome one or more of the above disadvantages, while at the same time not jeopardizing other favourable aspects of harvesting.

### SUMMARY OF THE INVENTION

The present invention relates to a method for harvesting mushrooms, wherein a container is used for directly growing mushrooms therein, thereby storing the mushrooms in said container, and harvesting mushrooms by removing the container comprising the mushrooms, to the container used in said harvesting method, as well as to use of said containers for harvesting mushrooms. The present invention provides a longer shelf life; due to the persistent conditions of moisture, temperature and inside of the bed, which remains the same even after mushrooms are detached. This technique of mushroom cultivation also enhances the shelf life by minimizing the level of contamination due to direct human touch and minimum exposure to the outer environment. Thus mushrooms stay fresh for a longer period of time.

The present method will significantly reduce the cost of mushroom production by virtually eliminating the process of harvesting and packaging. Nowadays, using prior art methods, mushroom pickers can harvest about 20-30 kg mushrooms per hour, depending on the size and type of mushrooms. With the present method a mushroom picker can easily harvest 100 kg per hour, that is at least 4-6 times as much as the prior art methods. In other words, in stead of picking one mushroom at a time, a picker can pick a container full in almost the same amount of time, that is e.g. from 10-1000 gr at a time, depending on the size of the container. As a consequence the costs of harvesting are reduced by 80% or more, most likely by 90% or more.

Despite the apparent advantages of the present invention, mushroom harvesting has not been developed accordingly. Further, in view of the huge market potential and turnover of mushroom, the present development is of the utmost importance to mushroom harvesting. The present combination of measures taken is, however, not disclosed in the prior art, nor is there a suggestion towards these measures.

Thus the present method provides a significantly longer shelf life of mushrooms, virtually no contamination by human beings, and virtually no contamination from the growth and storing environment, a cheap and fast method of harvesting, expansion of area of markets, limited transport costs, and mushrooms remain longer fresh and therefore need not to be transported and sold quickly.

The present container, as well as the use thereof, provide the above advantages as well.

Further advantages are mentioned below.

### DETAILED DESCRIPTION OF THE INVENTION

In a first aspect the present invention relates to a method for harvesting mushrooms, comprising the steps of

placing a container for growing and storing mushrooms comprising a bottom part having a lower part, with said lower part on a surface of a substrate used for mushroom growth, which bottom part comprises one or more first apertures in the lower part thereof,

growing mushrooms through the one or more first apertures into the container, and

harvesting grown mushrooms by removing the container comprising the mushrooms.

The invention is based on the idea that minimum exposure of the mushrooms, especially when growing, to outside environment keeps them healthy and less prone to contamination. The cultivation of mushrooms in the claimed invention keeps the mushrooms untouched right from the beginning until reached to the consumer. As such a premium brand of mushrooms is obtained.

An important difference with prior art methods is that harvesting mushrooms is not performed by human beings, at least not by picking them manually one by one. Further, the present method per se could be further automated, in the sense that harvesting could be done fully automatically with machines. Such machines are adapted to pick containers comprising mushrooms.

The term “mushroom” is used herein to refer to any type of mushroom, specifically edible and medicinal mushrooms. The term therefor includes the most familiar cultivated mushroom, Agaricus bisporus, and also includes other types of mushrooms, such as oyster mushrooms, criminy mushrooms, portobello mushrooms and shiitake mushrooms, just to mention a few.

The Agaricus bisporus is the most important mushroom in terms of units of production. A preferred embodiment of the present invention is therefore specifically applicable to Agaricus bisporus.

The present container should be suitable for growing and storing mushrooms. These containers are further detailed below. A container that is suitable for growing implies that at a point in time during growth a mushroom grows inside said container, whereas the substrate comprising nutrients, is outside the container. It further implies that mushrooms are largely inside said container when growing, specifically with their cap and stem, and only their foot is outside the container, in other words mushrooms grow through the bottom plate of a container.

Each container is placed on a substrate for mushroom growth. The substrate may be spread out through a large production unit, as in prior art methods. Nowadays the substrate typically comprises one or more layers, typically a compost layer and a peat layer on top thereof, though some of the above mentioned mushrooms require specific other substrates and configurations. However, any other type of substrate is envisaged, as long as the substrate is capable of producing mushrooms. The container is placed with it's bottom part on or close by the substrate.

As mushrooms start pinning, the mushrooms will grow through the one or more first apertures being present. Fruiting bodies will subsequently appear and grow further into the container. Surprisingly, and rather unexpected, the mushrooms will mainly appear in the apertures available, and not or almost not underneath the bottom plate. This is even further unexpected in that in principle the full area of the growing bed is available, especially the total area underneath the bottom part of the container, and virtually no pins or mushrooms are formed there. As a consequence the present method and containers are very effective in gathering growing mushrooms into the space available in the container. Virtually no mushrooms are lost in the harvesting process. Even further, any losses are already much less than those in prior art methods. As such in the present method the yield of mushrooms in terms of kilograms per unit area is equal, though in most cases larger than the yield of prior art methods. On the other hand, losses during harvesting are largely avoided, e.g. as the mushrooms stay untouched by human beings. The growth conditions are typically comparable to prior art methods. However, due to the presence of a container the mushrooms grow more spontaneously, which may partly be attributed to a better protection of the mushrooms.

When mushrooms have reached a required size or age the containers can be harvested, either by hand or automatically.

Harvesting of a container can be done one by one, that is sequentially removing an individual container from the substrate, or by harvesting a set of containers one by one, such as a set shown in FIGS. 14-18. A set of containers can for instance be placed in a tray. A set may comprise from 2-20 containers, or more, as is possible from a practical point of view. The containers are removed from the substrate, preferably by rotating the present container forth and back, preferably a few times. As a consequence of said method the mushrooms maintain longer healthy. Even further, the mushrooms, being situated in the container, can now be harvested by a machine, without jeopardizing the quality and/or health of the mushrooms. So also mushrooms harvested by a machine have the best possible quality.

Preferably the containers have a transparent part, preferably the top part thereof. The transparent part is then used to monitor the growth, either manually, or by visual aids, such as a camera. The camera can be monitored by an operator, or by a controller. Said operator or controller, e.g. a computer comprising software capable of interpreting visual information, is used to monitor growth of mushrooms, and adapt growth conditions, such a temperature, humidity, and moisture level of the substrate, if applicable. Further, the controller or operator determines the moment of harvesting. Then either an automated system is started to harvest the mushrooms, or human beings are instructed to start harvesting.

When the mushrooms are harvested they can be stored in a cooled environment, or shipped.

In a further preferred embodiment the present method is followed by the step of directly shipping and/or marketing of the container.

When the mushrooms have been harvested these are preferably directly shipped and placed on the market, being as fresh as possible. The present method and container provide such direct action.

As a consequence the mushrooms appear on the market much quicker, and more fresh.

In a second aspect the present invention relates to a container for growing and storing mushrooms comprising a top part and a bottom part, preferably being removably attached, wherein the bottom part comprises a substantially flat lower part with one or more first apertures and preferably a shallow base, and wherein the top part preferably comprises a maintainer for moisture level and one or more micro environment conditions.

The present container is suited for growing and storing mushrooms. Important therein is e.g. that micro environmental conditions can be controlled for longer period of time, mushrooms can be grown directly in the container, mushrooms can be stored in the container, for instance mushrooms should remain fresh as long as possible, mushrooms should be protected from physical damage as much as possible, etc.

Preferably the present container comprises a top and bottom part. Consumer can than by removing the top part obtain access to the mushrooms. Therefore the top and bottom part are preferably removably attached to each other. In a further preferred embodiment the top part and bottom part are attached by means of pins in one part and holes for receiving said pins in the other part. As such the two part are easily detachable.

To allow growth of mushrooms the bottom part comprises one or more apertures. The apertures need to be present in the substantially flat lower part (“bottom”) of the bottom part. The substantially flat lower part as such forms a plane, in which the apertures appear. Depending on the size of the mushrooms grown, these apertures are preferably placed at a distance apart from each other, which distance is approximately half the diameter of the cap of the mushroom. Further, the first apertures are preferably placed at a similar distance from the side walls of the bottom part.

In order to improve pinning and further growth of mushrooms the bottom part preferably comprises a shallow base.

As micro environmental conditions and moisture level during growth and during storing are important, the top part preferably comprises a maintainer therefore.

In a preferred embodiment the present container comprises a maintainer that comprises one or more second apertures. Such second apertures maintain the micro environmental conditions and moisture level during growth and during storing. The size of the second apertures and the number thereof can be adjusted by the person skilled in the art to obtain the required maintenance, for each respective case, i.e. for each type, size, and number of mushrooms grown, and combinations thereof. Typically 5-10 second apertures are present, each having an area of 0.2-1 cm².

In a preferred embodiment the container according to the invention comprises further means for preventing and/or reducing effects of contamination. Such means are for instance compositions comprising fungicide, insecticide, bactericide, etc, which are acceptable from a food point of view, that is not being poisonous of harmful to human beings.

In a further preferred embodiment the container according to the invention, comprises a bottom part which comprises 0.01-1 first apertures/cm², preferably 0.05-0.8 first apertures/cm², more preferably 0.1-0.7 first apertures/cm², even more preferably 0.25-0.6 first apertures/cm². In a further method the number of apertures are used to control the number of mushrooms growing in the present container. As such, the mushrooms appear in a certain density, i.e. number of mushrooms per unit area. The number of first apertures within the present container depends further on the size of container, that is the surface area of the bottom part of the container and number of apertures per unit area are limiting features.

The first apertures are preferably covered with a casing material for fruiting. Such a material supports the growth of mushrooms in an early stage of the growth process.

In a further preferred embodiment the container comprises first apertures that have an area of 0.25-10 cm²/aperture, preferably of 0.5-5 cm²/aperture. In a further method the size of apertures is used to control the size of the mushrooms growing, i.e. fewer apertures have large mushrooms growing, and more apertures have smaller mushrooms growing. The above is based on the insight that mushrooms have to compete amongst them for nutrients being present in the substrate; fewer apertures allow for larger mushrooms, whereas more apertures allow for smaller mushrooms, as a consequence thereof. In a further method the size of the aperture is varied throughout the container. As such the container comprises mushrooms in various sizes, as required. Further, the container is optimally filled with mushrooms, both in terms of space occupies as well as in terms of optimal conditions for growing and storing.

In a further preferred method size and number of mushrooms are controlled by adjusting the number of first apertures and sizes thereof. As such a large variety of sizes and number of mushrooms can be obtained.

In a further preferred embodiment the container comprises first apertures that have a round shape, an oval shape, or a multigonal shape, such as a square or rectangular shape, a hexagonal shape, a octagonal shape, or combinations thereof. The round shape is preferred, as it relates best to the natural shape of the stem of the mushroom. Other shapes are envisaged as well.

In a further preferred embodiment the container according to the invention is made of plastic, paper, soft board, cardboard, fibre, wood, or any synthetic material such as polyethylene, polystyrene or even made up of metal with defined apertures/holes on the base, or combinations thereof, and preferably part of the material used is transparent to visible light.

The shape of the present container can be any shape, that is round, oval, square, multigonal, etc. For transport purposed the shape is preferably square, rectangular or hexagonal. Special shapes are also envisaged. For instance, a heart shaped container could be used on Valentines day, star shaped at Christmas, but also special shapes for children, e.g. in the form of cartoon figures, are envisaged. In a third aspect the present invention relates to use of a container according to the invention for harvesting mushrooms.

The invention is further detailed by the accompanying figures, which are exemplary and explanatory of nature and are not limiting the scope of the invention.

### DESCRIPTION OF THE DRAWINGS/FIGURES

The invention although described in detailed explanatory context may be best understood in conjunction with the accompanying figures and photographs.

FIG. 1 is a view of a round substrate container composed of shallow base with three apertures and the deep top lid separated. The shallow base allows more room for growing mushrooms and poses less resistance to them.

FIG. 2 A view of the round substrate container composed of base with three apertures and the closed top lid. The secure lid is also perforated for air exchange and removal of excess moisture.

FIG. 3 Is a small round mushroom container with a shallow base plate and a detachable lid. This small container also has 3 apertures for the emerging mushrooms.

FIG. 4 A rectangular medium sized container with apertures at the bottom plate and perforation on the hinged lid.

FIG. 5 Another type of round deep large container with a flat shallow top lid. The top cover has a specific perforation for gaseous exchange. The wider upper region of the container allows more space for the growing mushrooms.

FIG. 6 Is a square shaped small deep substrate container with detachable cover. It has lesser capacity for mushrooms and suitable for a consumer who do not require more mushrooms at a time.

FIG. 7 Another view of rectangular container mounted on the compost on the compost bed. The see through capability provide chance to view and monitor the growing mushrooms all the time.

FIG. 8 The large round container placed on the compost tray and ready to initiate the process of growing.

FIG. 9 View of the sequential arrangement of large round containers on the small 2′×2′ compost bed.

FIG. 10 The arrangement of large round containers with deep covers is being set on the tray.

FIG. 11 A view of the rectangular trays placed on the compost bed are equipped with case and are started to grow.

FIG. 12 A set of the small round containers with shallow base.

FIG. 13 Shows a large round containers on the compost bed with full of mushrooms and ready to be detached.

FIG. 14 A view of the small compost tray with small round containers shows growing mushrooms.

FIG. 15 Mushrooms are growing in the medium sized rectangular trays.

FIG. 16 A view of growing mushrooms in the shallow based round containers.

FIG. 17 Mushrooms started to grow in the deep based round containers.

FIG. 18 A comparative view of the small round container with the shallow base.

FIG. 19 Shows a SEM picture of pinning mycelium of Agaricus bisporus.

FIG. 20 Shows a picture of mushrooms growing in a commercial mushroom farm.

### DETAILED DESCRIPTION OF THE DRAWINGS

FIG. 1 is a view of a round substrate container composed of a shallow base with in this example three apertures in the bottom part thereof and a top part which is separated from the bottom part. The shallow base allows for more space for growing mushrooms and further poses less resistance to the mushrooms. In FIG. 1 no mushrooms are visible. A typical diameter of the container is 10 cm.

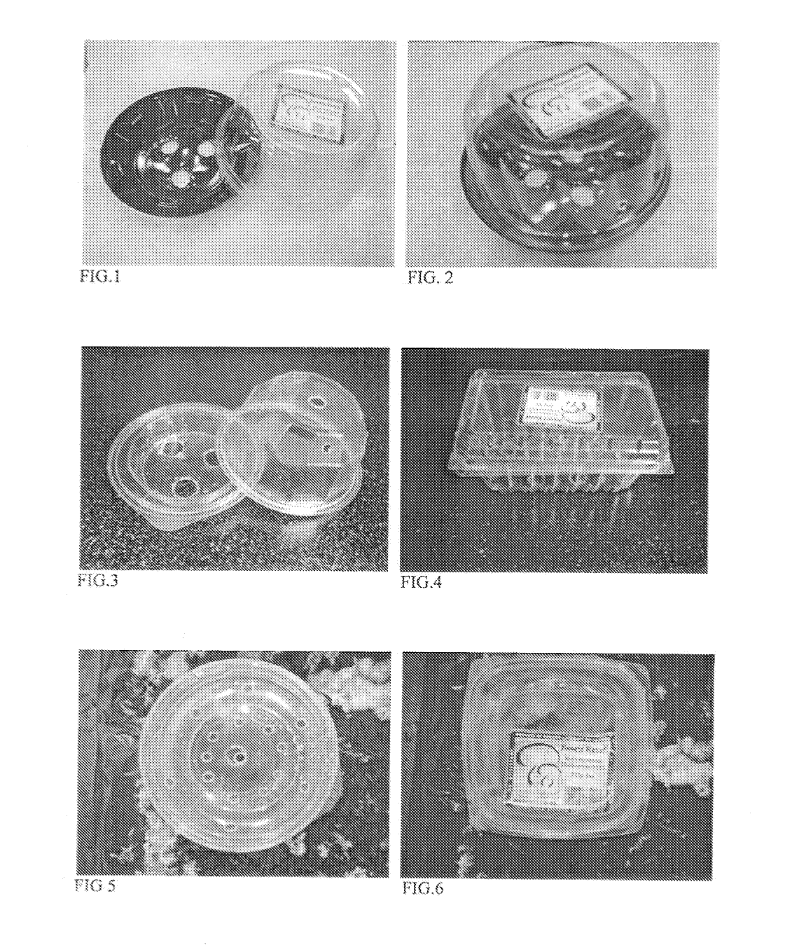

FIG. 2 shows a round substrate container composed of a bottom part with three apertures therein and a top part which forms a closed container with the bottom part. The top part also comprises second apertures for exchange of air and removal of excess moisture. A typical size of the container is 10 cm.

FIG. 3 shows a small round mushroom container with a shallow bottom plate and a detachable top plate. The small container also has three apertures in the bottom part for the emerging mushrooms, which are not visible in FIG. 3. Further, the to part as one larger second aperture and a few smaller apertures. The shape of the top part is multigonal, whereas the shade of the bottom part is substantially circular.

FIG. 4 shows a rectangular medium sized container, with various first apertures in the bottom part thereof, and perforations in the hinged lid, being attached to the bottom part and forming the top part of the container. The size of this rectangular container is about 20 cm×10 cm. The container offers space for some seven mushrooms, the mushrooms being of relatively large size. Bottom apertures are in the order of 1 cm² area. The perforations in the hinged lid are in the order of 0.5 cm².

FIG. 5 shows another type of a circular deep and large container with a flat shallow top part. The top part has various second apertures visible for gaseous exchange and for removal of excess moisture. Various water droplets are visible on the flat shallow top part. The wider upper region of the container allows for more space for the growing mushrooms. The bottom part has various first apertures. The diameter of the container is about 15 cm.

FIG. 6 shows a square shaped small deep container, with a detachable top part. As a consequence of lesser space being available the container has lesser capacity for mushrooms, and is therefore suitable for a customer who does not require many mushrooms at a time for consumption. The typical dimensions are 10 cm×10 cm. In the top part no apertures are visible, whereas in the bottom part various first apertures are present.

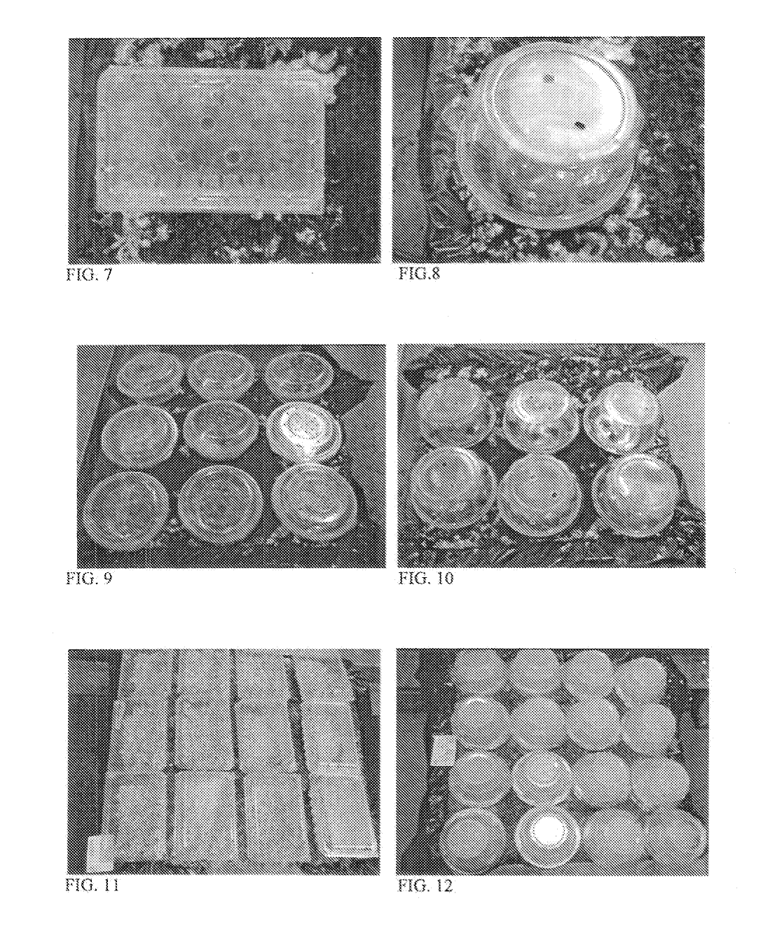

FIG. 7 relates to a rectangular container, which container is mounted on the compost on a compost bed. It has various first apertures in the bottom part, of approximately 2 cm² area, and it has openings in the top part in the hinged lid. The dimensions are about 15 cm×about 30 cm. The container is transparent, and therefore it provides a capability to view a monitor growing mushrooms over time. This ability provides the opportunity to control growth of mushrooms adequately and to determine the most advantageous time of harvesting the mushrooms inside the container.

FIG. 8 shows a relatively large circular container, placed on a compost tray and ready to initiate the process of growing mushrooms. It has two second apertures in the top part, and various apertures in the bottom part. The size of the container is about 15 cm, whereas the area of the second aperture is about 1 cm². Being transparent, the container offers similar advantages as the container of FIG. 7.

FIG. 9 shows a sequential arrangement of large round containers on a relatively small 2′×2′ compost bed. Each container is about 20 cm in diameter. The top part of each container comprises various relatively small second apertures.

FIG. 10 shows an arrangement of large round containers with deep covers that is being set on a tray. The top part of the container comprises two second apertures, the diameter of the containers is about 20 cm. The arrangement of containers is in principle ready for transport.

FIG. 11 shows a view of rectangular trays placed on a compost bed which are provided with casing material and are started to grow mushrooms. The mushrooms appear through the first apertures in the bottom part of the container. The size of the rectangular containers is about 15 cm×about 25 cm. The to part of the container comprises apertures in the hinged lid.

FIG. 12 shows a set of small round containers with a shallow base, as described in FIG. 3. These containers are placed on a compost bed of 2′×2′.

FIG. 13 shows one large container placed on a compost bed. The container is clearly full with mushrooms and is therefore ready to be harvested. The top part has various second apertures, whereas the bottom part as various first apertures. Through the first apertures a large variety in terms of size of mushrooms is grown.

FIG. 14 shows a view of a small compost tray with small round containers. Each of the containers comprises growing mushrooms. Again the large variety in size of growing mushrooms can be observed. The top part of the container has grown larger second apertures, whereas the bottom part has various first apertures.

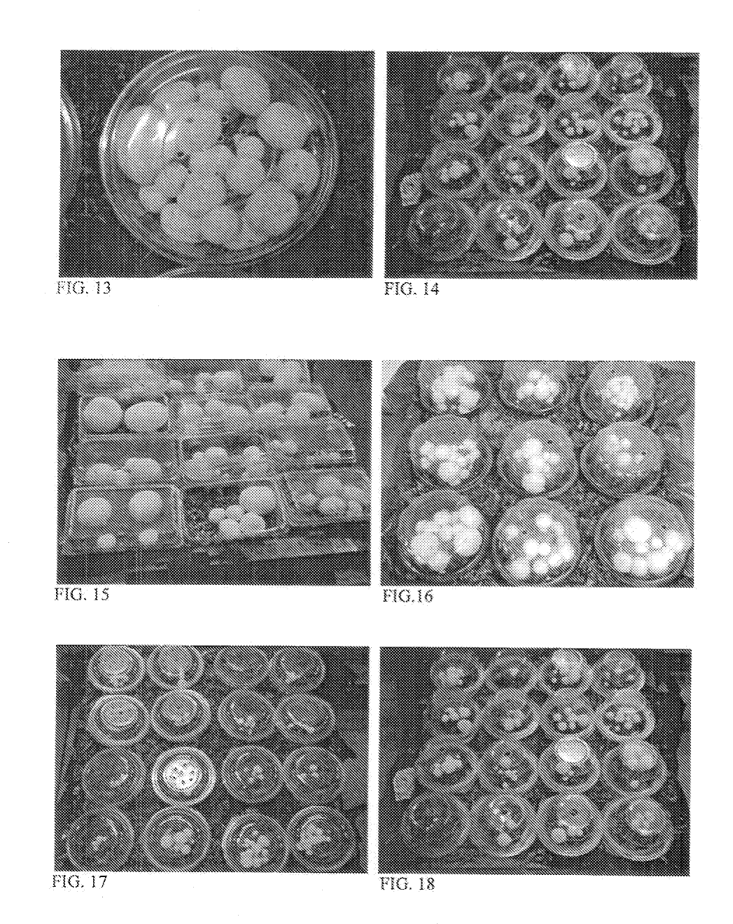

FIG. 15 relates to a tray of rectangular containers. Each container comprises various mushrooms. The hinged lid of the top part of the container comprises various second apertures. The set of containers is placed on a tray. Again it can be seen that the containers comprise a large variety in terms of size of mushrooms.

FIG. 16 shows similar containers as those in FIG. 10. A series of containers is placed on a tray. Therein mushrooms are growing in the shallow based round containers.

FIG. 17 shows mushrooms that are starting to grow in deep based round containers. The top part of the container comprises various second apertures.

FIG. 18 shows a comparative view of small round containers with a shallow base. Again therein various mushrooms are growing. The containers are comparable to those of FIG. 14.

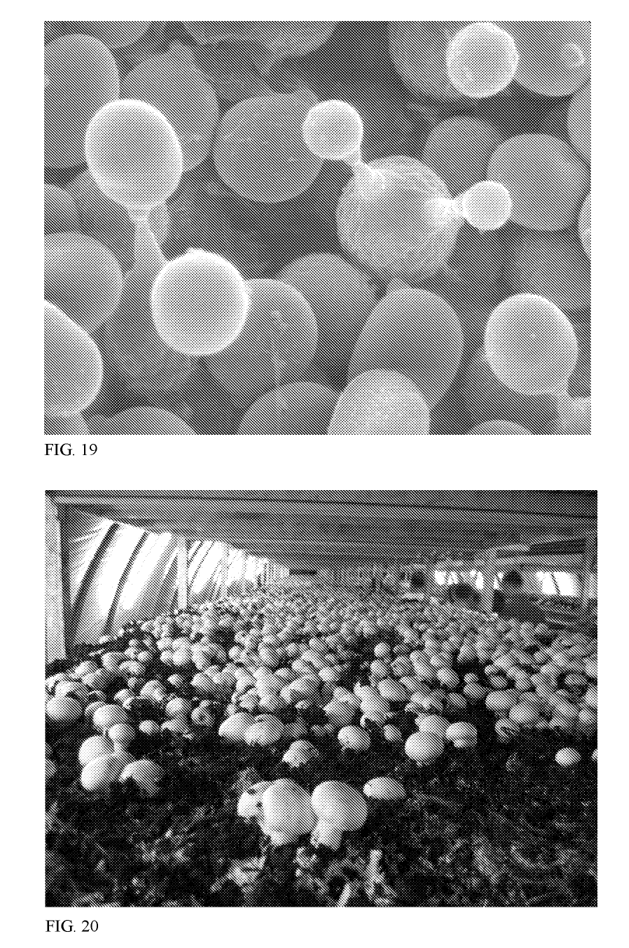

FIG. 19 Shows a SEM picture of pinning mycelium of Agaricus bisporus. The pins are the clear white areas in the SEM picture. Eventually these pins penetrate through the one or more first apertures of the present containers.

FIG. 20 Shows a picture of mushrooms (Agaricus Bisporus) growing in a commercial mushroom farm. The size of such a farm is typically in the order of tens of meters by a multitude thereof. The farm is subdivided in beds in order to allow access by human beings to the mushrooms to be harvested.

1. Method for harvesting mushrooms, comprising the steps of
placing a container for growing and storing mushrooms, comprising a bottom part having a lower part, with said lower part on a surface of a substrate used for mushroom growth, which bottom part comprises one or more first apertures in the lower part thereof,
growing mushrooms through the one or more first apertures into the container, and
harvesting grown mushrooms by removing the container comprising the mushrooms.

2. Method for harvesting mushrooms according to claim 1, followed by the step of directly shipping and/or marketing of the container.

3. Container for growing and storing mushrooms comprising a top part and a bottom part, preferably being removably attached, wherein the bottom part comprises a substantially flat lower part with one or more first apertures and preferably a shallow base, and wherein the top part preferably comprises a maintainer for moisture level and one or more micro environment conditions.

4. Container according to claim 3, wherein the maintainer comprises one or more second apertures.

5. Container according to claim 3, wherein the top part and bottom part are attached by means of pins in one part and holes for receiving said pins in the other part.

6. Container according to claim 3, comprising further means for preventing and/or reducing effects of contamination.

7. Container according to claim 3, wherein the bottom part comprises 0.2-1 first apertures/cm², preferably 0.5-0.8 first apertures/cm², wherein the first apertures have an area of 0.25-10 cm²/aperture, preferably of 0.5-5 cm²/aperture, wherein the apertures preferably have a round shape, an oval shape, or a multigonal shape, such as a square or rectangular shape, a hexagonal shape, a octagonal shape, or combinations thereof.

8. Container according to claim 3, wherein the container is made of plastic, paper, soft board, cardboard, or combinations thereof, and where preferably part of the material is transparent to visible light.

9. A method of harvesting mushrooms using a container according to claim 3.
